(19) United States
(12) Patent Application Publication
(10) Pub. No.: US 2008/0106050 A1
(43) Pub. Date: May 8, 2008

(54) Push Cart With Coupling Device

(75) Inventors: Hammerle Jurgen, Gunzburg (DE); Stockle Dieter, Landensberg (DE)

Correspondence Address: BUCHANAN, INGERSOLL & ROONEY PC, POST OFFICE BOX 1404, ALEXANDRIA, VA, 22313-1404, US

(73) Assignee: WANZL METALLWARENFABRIK GMBH, Leipheim (DE)

(21) Appl. No.: 11/934,121

(22) Filed: Nov. 2, 2007

(30) Foreign Application Priority Data
Nov. 2, 2006 (DE) 102006158.7

(51) Int. Cl. B62B 3/14

(52) U.S. Cl. 280/33.994

(57) ABSTRACT

A push cart includes a device, which is supplied with energy, and which includes a coupling device that is supplied with a mounting; a sliding part is retractably insertable into the mounting; a slide valve inside the coupling device is movable back and forth from a first to a second position, whereby when the slide valve is in the first position, the sliding part can be removed and when the slide valve is in the second position, the sliding part is locked in the coupling device. The coupling device further includes a magnet, wherein the magnet can move the slide valve between the first and the second position by changing the polarity of the magnet.

### CROSS-REFERENCE TO RELATED APPLICATIONS

The present application claims the benefit of DE 10 2006 052 158.7, which was filed in Germany on Nov. 2, 2006, the entire contents of which is incorporated herein by reference.

### FIELD OF THE INVENTION

The invention concerns a push cart movable by hand.

### BACKGROUND OF THE INVENTION

Push carts are known with devices that are supplied with energy. In the prior art, one such device is a deposit lock. Such a deposit lock, as described, e.g., in European patent specification EP 1 101 204 B1, has a side for mounting a sliding part and a further mounting for deposit, such as a coin. The power supply is connected after introducing a deposit in the deposit lock and interrupted when returned.

Examples of locking devices may also be found in U.S. Pat. Nos. 5,121,823 and 6,830,252, the contents of which are incorporated herein by reference.

### OBJECTS AND SUMMARY

The present disclosure describes an improved device for a push cart with a deposit lock.

With such a device with a coupling, a security, like, e.g., a coin, can be saved.

With use of a bistable magnet, the power requirement is very low.

The parts assortment can remain low due to the simple design of the device, which leads to a cost saving for such a device.

### BRIEF DESCRIPTION OF THE DRAWINGS

The embodiments of the invention are explained in more detail using a design example, showing:

FIG. 1 a push cart with an embodiment of the present invention;

FIG. 2 a device in cross-section with a released sliding part as it is used in push carts;

FIG. 3 the same device in cross-section with locked sliding part;

FIG. 4 the same device in 3-D representation with released sliding part as well

FIG. 5 the same device in 3-D representation with locked sliding part.

### DETAILED DESCRIPTION OF THE PREFERRED EMBODIMENTS

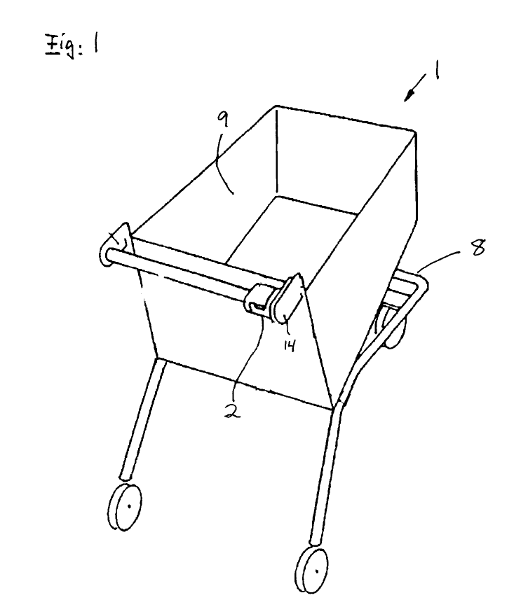

FIG. 1 shows a push cart 1 with a device 2 that enables coupling of similar carts. The device 2 includes a coupling device 3 which can be used in a push cart 1. Such devices 2 serve to stack push carts 1 with similar push carts 1 in a known manner in a space-saving line. Such a push cart 1 includes a chassis 8 and a space 9 for merchandise or other goods. The space 9 can be formed, for example, as a basket. Furthermore, each cart 1 is equipped with a sliding device (not shown) that includes preferably two sliding handle sections, which are usually separated from each other. The device and the sliding handle sections can be formed as one part or several parts. The position of the device is left to the specialist.

Such a device 2 includes a housing. In the housing are arranged different components. The device is operable by means of a display, which is preferably designed as a touchscreen. Thus, different information can be entered and/or requested by a customer.

An energy source 14 is provided on the cart 1. Depending on the requirement, such an energy source 14 is provided and/or arranged on the cart 1, e.g., by being built into components of the cart 1. The energy source can, for example, be formed as a battery. Other kinds of energy sources are, however, also conceivable. The device 2 is thus supplied with energy.

The device 2 is preferably manufactured from plastic. On the device 2, preferably on the bottom, an opening is provided, which is locked with a disk. A reading device is provided inside the device 2. This reading device is preferably implemented in the form of a scanner.

For releasing a cart 1 from a line of carts, each customer holds his customer card for identification by the reading device 15 of the device 2. Each device 2 includes a control 16. If a customer is identified, the locking of a coupling device 3, which is arranged in the device 2, is cancelled.

A mounting 7 is provided in the coupling device 3, which accepts a sliding part 4. Furthermore, a slide valve 5 is provided in the coupling device 3, which can be moved into a first and a second position. The coupling device 3 thus has two positions. In the first position, the sliding part 4 can be withdrawn or removed; in the second position, the sliding part 4 is blocked and/or locked. The coupling device 3 includes a magnet 6 and, depending upon the polarity of the magnet 6, the slide valve 5 is moved into the first or the second position.

The starting point, according to the FIGS. 3 and 5, is the second position, wherein the sliding part 4 is locked.

When the coupling device 3 of the device 2 is locked, the sliding part 4 is introduced into the coupling device 3, and cannot be withdrawn or removed. Removal of the sliding part 4 is blocked by the magnet 6. The magnet 6 preferably has a U-shaped profile. This form serves to accept a pin 17 that can be attracted or repelled by the magnet 6. The pin 17 preferably functions as a cylinder. The pin 17 is connected with the slide valve 5. The kind of connection is left to the specialist. Preferably, a positive connection is provided.

The slide valve 5 includes a mounting 5.1 for a spring component 18. The spring component 18 is compressed. The use of a pressure spring has proved advantageous.

A distance is provided between slide valve 5 and the housing 21 of the coupling device 3. The movement of the slide valve 5 is limited by stops 25.1 and 25.2, which are both formed by the housing 21 of the coupling system 21. See FIG. 3.

The slide valve 5 includes a space 5.2 for a ball 19. The sliding part 4 is provided, which preferably is implemented as a key. The sliding part 4 includes an opening 20. The opening 20 includes a round diameter and is formed in such a manner that the diameter of the ball 19 can be completely taken into the opening 20. Each coupling device 3 preferably includes a two-piece housing 21. In the upper part 23 are preferably arranged the magnet 6, the slide valve 5, as well as the pin 17. The lower part 24 includes the mounting 7 for the sliding part 4 and a push button 22. The ball 19 is in the lower part 24; however, it has the possibility of also filling out the area of the lower mounting 5.2 of the slide valve 5.

The ball 19 rests upon the bottom of the housing 21. Thus, it exercises a blocking function.

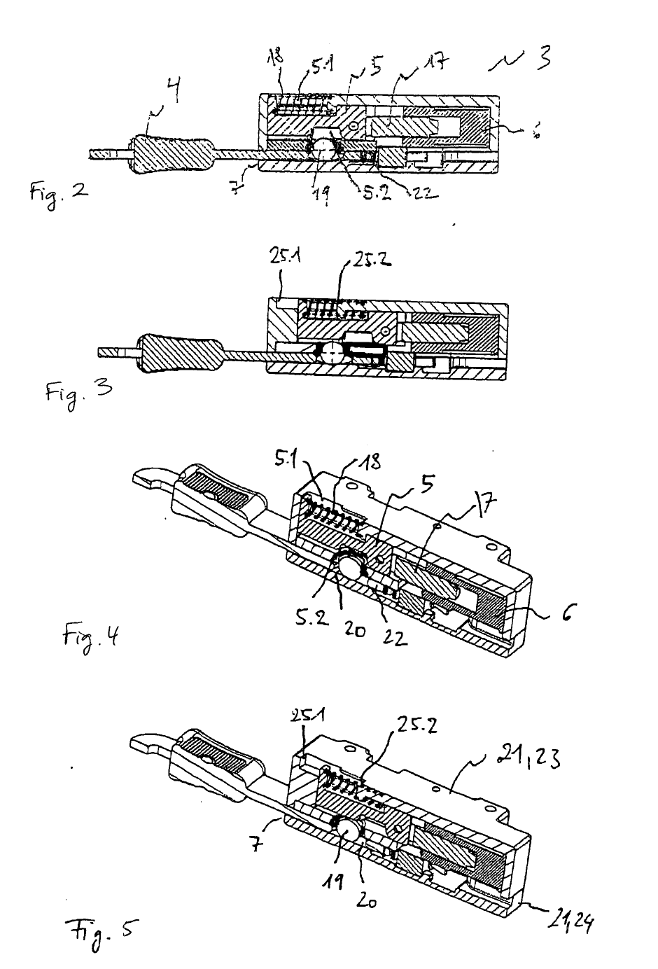

If a customer is identified, the polarity of the magnet 6 is changed, thus causing the sliding valve 5 to move to the first position and the customer can withdraw or remove the sliding part 4. FIGS. 2 and 4 show the first position. In the first position, the ball 19 can move up into the space 5.2, thus enabling the sliding part 4 to be removed.

First of all, a control causes a pole reversal of the magnetic field. Because the pin 17 is a component that reacts to a magnetic field, the pin 17 is now no longer attracted by the magnet 6, but repelled. As magnet 6, a bistable magnet 6 has proved successful. The magnet 6 is preferably an electromagnet.

By the connection of pin 17 and the slide valve 5, both components move toward the mounting 7 of the sliding part 4. By the movement of the slide valve 5, a relaxation of the spring component 18 takes place. Furthermore, the space 5.2 for the ball 19 is now arranged in such a manner that the ball 19 can move into the space 5.2 when the sliding part 4 is pulled out. Thus, the sliding part 4 can be taken out of the coupling device 3.

The same distance is now formed between pin 17 and magnet 6 by the movement of the components.

If the cart 1 is to be stacked again into another cart 1, the sliding part 4 is inserted into mounting 7. By inserting the sliding part 4, the ball 19 moves into the lower mounting 5.2. The ball 19 is completely taken in by the space 5.2. The sliding part 4 must be pushed up to a push button 22. By means of the contact of push button 22 and sliding part 4, a pole reversal of the magnet 6 takes place, which entails an attraction of the pin 17. Thus, the slide valve 5 also moves again into the second position, the spring component 18 is tensed, and the ball 19 automatically moves from the lower mounting 5.2 into the opening 20 of the sliding part 4, which results in a locking.

The housing 21 of the coupling device 3 as well as sliding part 4 are preferably made of a pressure-resistant and slidable plastic. A PA or POM has proved practical.

It will be apparent to those skilled in the art that various modifications and variations of the present invention can be made without departing from the spirit and scope of the invention. Thus, it is intended that the present invention include the modifications and variations of this invention provided they come within the scope of the appended claims and their equivalents.

1. A push cart comprising:
a device, which is supplied with energy, and which includes a coupling device that is supplied with a mounting;
a sliding part is retractably insertable into the mounting;
a slide valve inside the coupling device is movable back and forth from a first to a second position, whereby when the slide valve is in the first position, the sliding part can be removed and when the slide valve is in the second position, the sliding part is locked in the coupling device;
the coupling device further includes a magnet, wherein the magnet can move the slide valve between the first and the second position by changing the polarity of the magnet.

2. The push cart according to claim 1, wherein the magnet is a bistable magnet.

3. The push cart according to the claim 1, wherein the magnet is an electromagnet.

4. The push cart according to the claim 2, wherein the magnet is an electromagnet.

5. The push cart according to the claim 1, further comprising a ball in the mounting, and the slide valve includes a space for the ball.

6. The push cart according to the claim 5, wherein the sliding part includes a space for the ball, and when the slide valve is in the first position, the ball can move into the space for the ball and when the slide valve is in the second position the ball cannot move into the space for the bal.
